(19) United States
(12) Patent Application Publication
(10) Pub. No.: US 2025/0251268 A1
(43) Pub. Date: Aug. 7, 2025

(54) A PRESSURE COMPENSATION OF A FLUID FLOW PARAMETER

(71) Applicant: MICRO MOTION, INC., Boulder, CO (US)

(72) Inventors: Andrew Timothy PATTEN, Gunnison, CO (US); Anthony William PANKRATZ, Arvada, CO (US)

(73) Assignee: MICRO MOTION, INC., Boulder, CO (US)

(21) Appl. No.: 18/854,191

(22) PCT Filed: Apr. 12, 2022
(86) PCT No.: PCT/US2022/024428

§ 371 Date: Oct. 4, 2024

(51) Int. Cl. G01F 15/02; G01F 1/84

(52) U.S. Cl. CPC G01F 15/022; G01F 1/8427

(57) ABSTRACT

A method of pressure compensation of a fluid flow parameter is provided. The method comprises receiving a measured pipeline pressure value of a fluid in a pipeline, and determining, based on the measured pipeline pressure value, a pressure for determining a pressure compensated fluid flow parameter value.

### TECHNICAL FIELD

The embodiments described below relate to correcting a fluid flow parameter measured by a vibratory meter and, more particularly, to pressure compensation of a fluid flow parameter.

### BACKGROUND

Vibratory meters, such as for example, Coriolis mass flowmeters, liquid density meters, gas density meters, liquid viscosity meters, gas/liquid specific gravity meters, gas/liquid relative density meters, and gas molecular weight meters, are generally known and are used for measuring fluid parameters. Generally, vibratory meters comprise a sensor assembly and a meter electronics. The material within the sensor assembly may be flowing or stationary. The vibratory meter may be used to measure the one or more fluid parameters such as mass flow rate, density, or other properties of a material in the sensor assembly.

The vibratory meter or, more particularly, the sensor assembly, may be in-line with a pipeline. More specifically, an inlet of the sensor assembly may be fluidly coupled to an inlet pipeline and an outlet of the sensor assembly may be fluidly coupled to an outlet pipeline. The sensor assembly typically includes one or more conduits, which may be referred to as flow tubes, that vibrate to measure the one or more fluid parameters. These conduits may have a diameter that is smaller than a diameter of a pipeline that vibratory meter is in-line with. As a result, the fluid in the conduit may experience an increase in fluid velocity, which can cause a corresponding reversible or dynamic pressure drop. There may also be corresponding pressure losses or irreversible pressure drops due to friction, turbulence, or the like.

The pressure drop, reversible and/or irreversible, may affect a measurement of a fluid flow parameter. For example, a measured density error may increase as the fluid flow velocity increases. Similar issues may arise with mass flow rate, or other fluid flow parameter values. The quantitative effect of these issues may be relatively small and may or may not adversely affect a process using the vibratory meter. However, consumers of the vibratory meters may be aware that there may be a pressure effect on the fluid flow parameter value. The consumer may also request information on whether there is a specified location (e.g., upstream, downstream, distance, and/or etc.) for a pipeline pressure measurement to determine the pressure effect on the fluid flow parameter value. Accordingly, there is a need for pressure compensation of a fluid flow parameter.

### SUMMARY

A method of pressure compensation of a fluid flow parameter is provided. According to an embodiment, the method comprises receiving a measured pipeline pressure value of a fluid in a pipeline, and determining, based on the measured pipeline pressure value, a pressure for determining a pressure compensated fluid flow parameter value. A meter electronics, a vibratory meter, and a system configured to perform the foregoing method are also provided.

### ASPECTS

According to an aspect, a method of pressure compensation of a fluid flow parameter comprises receiving a measured pipeline pressure value of a fluid in a pipeline, and determining, based on the measured pipeline pressure value, a pressure for determining a pressure compensated fluid flow parameter value.

Preferably, the measured pipeline pressure value comprises one of a measured inlet pipeline pressure value and a measured outlet pipeline pressure value.

Preferably, determining, based on the measured pipeline pressure value, the pressure for determining the pressure compensated fluid flow parameter value comprises determining a calculated pressure based on one of the following equations:

$${P}_{c} = ( {P}_{1} + ρ \frac{{V}_{1}^{2}}{2} ) - \frac{1}{2} ( permanent pressure loss ) - ( dynamic pressure drop ) ; \\ and$$

$${P}_{c} = ( {P}_{3} + ρ \frac{{V}_{3}^{2}}{2} ) + \frac{1}{2} ( permanent pressure loss ) - ( dynamic pressure drop ) ;$$

where:
P₁ is the measured inlet pipeline pressure value;
V₁ is a velocity of the fluid in an inlet pipeline;
P₃ is the measured outlet pipeline pressure value;
V₃ is a velocity of the fluid in the outlet pipeline;
P_{c} is the calculated pressure;
ρ is a density of the fluid;
(permanent pressure loss) is a permanent pressure loss value of a vibratory meter connected to the pipeline; and
(dynamic pressure drop) is a dynamic pressure drop associated with a diameter difference between a conduit of the vibratory meter and a pipeline connected to the vibratory meter.

Preferably, the pressure for determining the pressure compensated fluid flow parameter value is based on a pressure loss associated with at least one of a conduit, an inlet manifold, and an outlet manifold.

Preferably, the pressure loss associated with the conduit comprises at least one of a friction pressure loss and a bend pressure loss of the conduit.

Preferably, the pressure for determining the pressure compensated fluid flow parameter value comprises one of the following equations:

$${P}_{C} = {P}_{1} - \frac{ρ {V}_{2}^{2}}{2} ( {K}_{m inlet} + \frac{1}{2} \frac{fL}{d} + {K}_{b} ) - \frac{ρ {V}_{2}^{2}}{2} ; and \\ {P}_{C} = {P}_{3} + \frac{ρ {V}_{2}^{2}}{2} ( {K}_{m inlet} + \frac{1}{2} \frac{fL}{d} + {K}_{b} ) - \frac{ρ {V}_{2}^{2}}{2} ;$$

where:
P₁ is a measured pressure of an inlet pipeline;

$$\frac{ρ {V}_{2}^{2}}{2} ( {K}_{m inlet} + \frac{1}{2} \frac{fL}{d} + {K}_{b} )$$

is a permanent pressure loss term;

$$\frac{ρ {V}_{2}^{2}}{2}$$

is a dynamic pressure loss term;
ρ is a density of the fluid;
V₂ is a velocity of the fluid in the conduit;
K_{m inlet} is a manifold pressure loss factor;
f is a friction factor of the conduit;
L is an overall length of the conduit;
d is a diameter of the conduit; and
K_{b} is a bend pressure loss factor.

Preferably, determining, based on the measured pipeline pressure value, a pressure for determining a pressure compensated fluid flow parameter value comprises determining if the pressure for determining the pressure compensated fluid flow parameter value is one of a calculated pressure value and the measured pipeline pressure value.

Preferably, determining, based on the measured pipeline pressure value, the pressure for determining the pressure compensated fluid flow parameter value comprises determining an error of the pressure compensated fluid flow parameter value.

According to an aspect, a meter electronics configured for pressure compensation of a fluid flow parameter value comprises an interface configured to communicatively couple to a pressure sensor configured to measure a pipeline pressure of a fluid in the pipeline, and a processing system communicatively coupled to the interface, the processing system being configured to perform the methods described in the foregoing.

According to an aspect, a vibratory meter configured to determine a pressure for pressure compensation of a fluid flow parameter value comprises a sensor assembly configured to provide sensor signals, and a meter electronics communicatively coupled to the sensor assembly, the meter electronics being configured to receive the sensor signals and perform the methods described in the foregoing.

According to an aspect, a system for determining a pressure for pressure compensation of a fluid flow parameter value, the system comprising a pressure sensor configured to measure pipeline pressure, and a vibratory meter communicatively coupled to the pressure transducer, the vibratory meter being configured to perform the methods described in the foregoing.

### BRIEF DESCRIPTION OF THE DRAWINGS

The same reference number represents the same element on all drawings. It should be understood that the drawings are not necessarily to scale.

FIG. 1 shows a vibratory meter 5 configured to determine a pressure for pressure compensation of a fluid flow parameter value.

FIG. 2 shows a block diagram of the vibratory meter 5, including a block diagram representation of the meter electronics 20, configured to perform pressure compensation of a fluid flow parameter value.

FIG. 3 shows a meter electronics 20 for pressure compensation of a fluid flow parameter value.

FIG. 4 shows a system 400 for pressure compensation of a flow meter parameter.

FIG. 5 shows a graph 500 illustrating a pressure compensation of a fluid flow parameter.

FIG. 6 shows a method 600 for pressure compensation of a fluid flow parameter.

### DETAILED DESCRIPTION

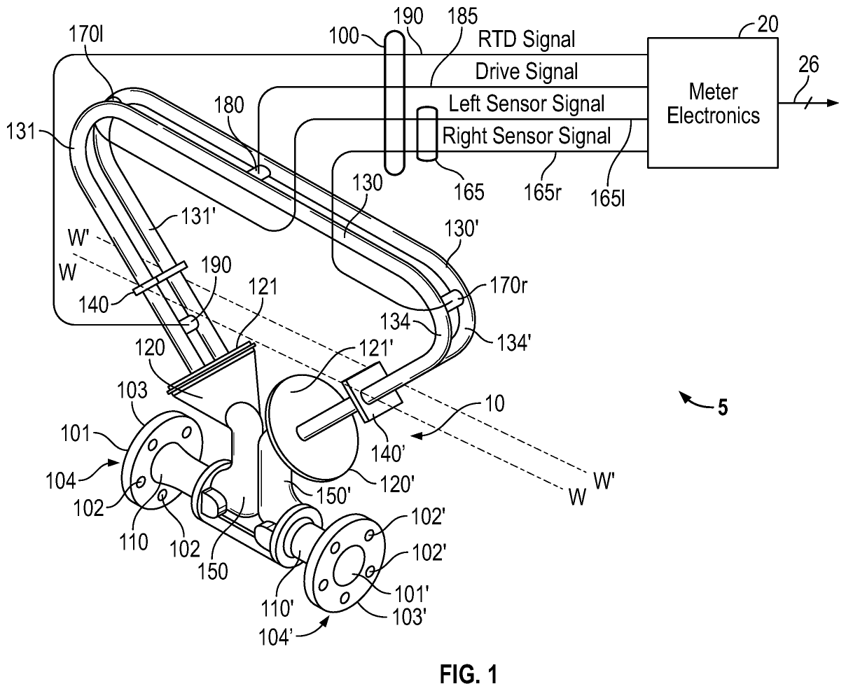

FIGS. 1-6 and the following description depict specific examples to teach those skilled in the art how to make and use the best mode of embodiments of determining a pressure for pressure compensation of a fluid flow parameter value. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of determining a pressure for pressure compensation of a fluid flow parameter value. As a result, the embodiments described below are not limited to the specific examples described below, but only by the claims and their equivalents.

FIG. 1 shows a vibratory meter 5 configured to determine a pressure for pressure compensation of a fluid flow parameter value. As shown in FIG. 1, the vibratory meter 5 comprises a sensor assembly 10 and meter electronics 20. The sensor assembly 10 responds to mass flow rate and density of a process material. The meter electronics 20 is connected to the sensor assembly 10 via leads 100 to provide density, mass flow rate, and temperature information over port 26, as well as other information.

The sensor assembly 10 includes a pair of manifolds 150 and 150′, flanges 103 and 103′ having flange necks 110 and 110′, a pair of parallel conduits 130 and 130′, driver 180, resistive temperature detector (RTD) 190, and a pair of pick-off sensors 170l and 170r. Conduits 130 and 130′ have two essentially straight inlet legs 131, 131′ and outlet legs 134, 134′, which converge towards each other at conduit mounting blocks 120 and 120′. The conduits 130, 130′ bend at two symmetrical locations along their length and are essentially parallel throughout their length. Brace bars 140 and 140′ serve to define the axis W and W′ about which each conduit 130, 130′ oscillates. The legs 131, 131′ and 134, 134′ of the conduits 130, 130′ are fixedly attached to conduit mounting blocks 120 and 120′ and these blocks, in turn, are fixedly attached to manifolds 150 and 150′. This provides a continuous closed material path through sensor assembly 10.

When flanges 103 and 103′, having holes 102 and 102′ are connected, via inlet end 104 and outlet end 104′ into a process line (not shown) which carries the process material that is being measured, material enters inlet end 104 of the meter through an orifice 101 in the flange 103 and is conducted through the manifold 150 to the conduit mounting block 120 having a surface 121. Within the manifold 150 the material is divided and routed through the conduits 130, 130′. Upon exiting the conduits 130, 130′, the process material is recombined in a single stream within the block 120′ having a surface 121′ and the manifold 150′ and is thereafter routed to outlet end 104′ connected by the flange 103′ having holes 102′ to the process line (not shown).

The conduits 130, 130′ are selected and appropriately mounted to the conduit mounting blocks 120, 120′ so as to have substantially the same mass distribution, moments of inertia and Young's modulus about bending axes W-W and W′-W′, respectively. These bending axes go through the brace bars 140, 140′. Inasmuch as the Young's modulus of the conduits change with temperature, and this change affects the calculation of flow and density, RTD 190 is mounted to conduit 130′ to continuously measure the temperature of the conduit 130′. The temperature of the conduit 130′ and hence the voltage appearing across the RTD 190 for a given current passing therethrough is governed by the temperature of the material passing through the conduit 130′. The temperature dependent voltage appearing across the RTD 190 is used in a well-known method by the meter electronics 20 to compensate for the change in elastic modulus of the conduits 130, 130′ due to any changes in conduit temperature. The RTD 190 is connected to the meter electronics 20 by lead 195.

Both of the conduits 130, 130′ are driven by driver 180 in opposite directions about their respective bending axes W and W′ and at what is termed the first out-of-phase bending mode of the vibratory meter. This driver 180 may comprise any one of many well-known arrangements, such as a magnet mounted to the conduit 130′ and an opposing coil mounted to the conduit 130 and through which an alternating current is passed for vibrating both conduits 130, 130′. A suitable drive signal 185 is applied by the meter electronics 20, via a lead, to the driver 180.

The meter electronics 20 receives the RTD temperature signal on lead 195, and sensor signals 165 appearing on leads 100 carrying left and right sensor signals 165l, 165r, respectively. The meter electronics 20 produces the drive signal 185 appearing on the lead to driver 180 and vibrate conduits 130, 130′. The meter electronics 20 processes the left and right sensor signals 165l, 165r and the RTD signal 195 to compute the mass flow rate and the density of the material passing through sensor assembly 10. This information, along with other information, is applied by meter electronics 20 over port 26 as a signal. A more detailed discussion of the meter electronics 20 follows.

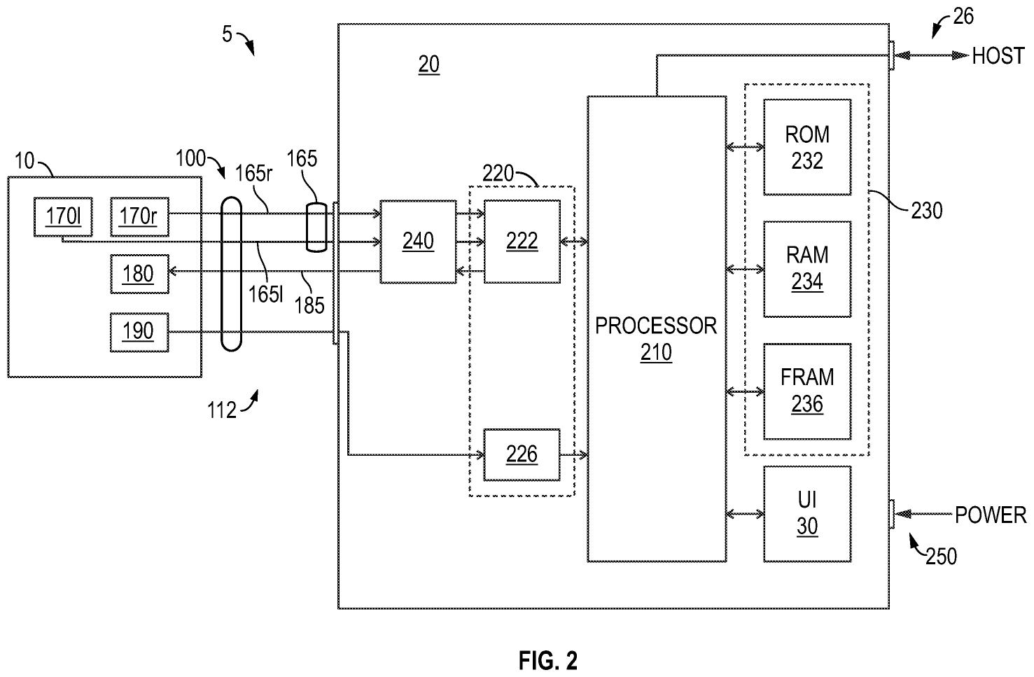

FIG. 2 shows a block diagram of the vibratory meter 5, including a block diagram representation of the meter electronics 20, configured to perform pressure compensation of a fluid flow parameter value. As shown in FIG. 2, the meter electronics 20 is communicatively coupled to the sensor assembly 10. As described in the foregoing with reference to FIG. 2, the sensor assembly 10 includes the left and right pick-off sensors 170l, 170r, driver 180, and temperature sensor 190, which are communicatively coupled to the meter electronics 20 via the set of leads 100 through a communications channel 112.

The meter electronics 20 provides a drive signal 185 via the leads 100. More specifically, the meter electronics 20 provides a drive signal 185 to the driver 180 in the sensor assembly 10. In addition, sensor signals 165 comprising the left sensor signal 165l and the right sensor signal 165r are provided by the sensor assembly 10. More specifically, in the embodiment shown, the sensor signals 165 are provided by the left and right pick-off sensor 170l, 170r in the sensor assembly 10. As can be appreciated, the sensor signals 165 are respectively provided to the meter electronics 20 through the communications channel 112.

The meter electronics 20 includes a processor 210 communicatively coupled to one or more signal processors 220 and one or more memories 230. The processor 210 is also communicatively coupled to a user interface 30. The processor 210 is communicatively coupled with the host via a communication port over the port 26 and receives electrical power via an electrical power port 250. The processor 210 may be a microprocessor although any suitable processor may be employed. For example, the processor 210 may be comprised of sub-processors, such as a multi-core processor, serial communication ports, peripheral interfaces (e.g., serial peripheral interface), on-chip memory, I/O ports, and/or the like. In these and other embodiments, the processor 210 is configured to perform operations on received and processed signals, such as digitized signals.

The processor 210 may receive digitized sensor signals from the one or more signal processors 220. The processor 210 is also configured to provide information, such as a phase difference, a property of a fluid in the sensor assembly 10, or the like. The processor 210 may provide the information to the host through the communication port. The processor 210 may also be configured to communicate with the one or more memories 230 to receive and/or store information in the one or more memories 230. For example, the processor 210 may receive calibration factors and/or sensor assembly zeros (e.g., phase difference when there is zero flow) from the one or more memories 230. Each of the calibration factors and/or sensor assembly zeros may respectively be associated with the vibratory meter 5 and/or the sensor assembly 10. The processor 210 may use the calibration factors to process digitized sensor signals received from the one or more signal processors 220.

The one or more signal processors 220 is shown as being comprised of an encoder/decoder (CODEC) 222 and an analog-to-digital converter (ADC) 226. The one or more signal processors 220 may condition analog signals, digitize the conditioned analog signals, and/or provide the digitized signals. The CODEC 222 is configured to receive the sensor signals 165 from the left and right pick-off sensors 170l, 170r. The CODEC 222 is also configured to provide the drive signal 185 to the driver 180. In alternative embodiments, more or fewer signal processors may be employed.

As shown, the sensor signals 165 are provided to the CODEC 222 via a signal conditioner 240. The drive signal 185 is provided to the driver 180 via the signal conditioner 240. Although the signal conditioner 240 is shown as a single block, the signal conditioner 240 may be comprised of signal conditioning components, such as two or more op-amps, filters, such as low pass filters, voltage-to-current amplifiers, or the like. For example, the sensor signals 165 may be amplified by a first amplifier and the drive signal 185 may be amplified by the voltage-to-current amplifier. The amplification can ensure that the magnitude of the sensor signals 165 is approximate the full-scale range of the CODEC 222.

In the embodiment shown, the one or more memories 230 is comprised of a read-only memory (ROM) 232, random access memory (RAM) 234, and a ferroelectric random-access memory (FRAM) 236. However, in alternative embodiments, the one or more memories 230 may be comprised of more or fewer memories. Additionally, or alternatively, the one or more memories 230 may be comprised of different types of memory (e.g., volatile, non-volatile, etc.). For example, a different type of non-volatile memory, such as, for example, erasable programmable read only memory (EPROM), or the like, may be employed instead of the FRAM 236. The one or more memories 230 may be a storage configured to store process data, such as drive or sensor signals, mass flow rate or density measurements, etc.

A mass flow rate measurement can be generated according to the equation:

$$\dot{m} = FCF [ Δ t - Δ {t}_{0} ] ; \qquad [ 1 ]$$

where:
\dot{m} is a measured mass flow rate;
FCF is a flow calibration factor;
Δt is a measured time delay; and
Δt₀ is a zero-flow time delay.
   The measured time delay Δt comprises an operationally-derived (i.e., measured) time delay value comprising the time delay existing between the pickoff sensor signals, such as where the time delay is due to Coriolis effects related to mass flow rate through the vibratory meter 5. The measured time delay Δt is a direct measurement of a mass flow rate of the flow material as it flows through the vibratory meter 5. The zero-flow time delay Δt₀ comprises a time delay at a zero flow. The zero-flow time delay Δt₀ is a zero-flow value that may be determined at the factory and programmed into the vibratory meter 5. The zero-flow time delay Δt₀ is an exemplary zero-flow value. Other zero-flow values may be employed, such as a phase difference, time difference, or the like, that are determined at zero flow conditions. A value of the zero-flow time delay Δt₀ may not change, even where flow conditions are changing. A mass flow rate value of the material flowing through the vibratory meter 5 is determined by multiplying a difference between measured time delay Δt and a reference zero-flow value Δt₀ by the flow calibration factor FCF. The flow calibration factor FCF is proportional to a physical stiffness of the vibratory meter.

As to density, a resonance frequency at which each conduit 130, 130′ may vibrate may be a function of the square root of a spring constant of the conduit 130, 130′ divided by the total mass of the conduit 130, 130′ having a material. The total mass of the conduit 130, 130′ having the material may be a mass of the conduit 130, 130′ plus a mass of a material inside the conduit 130, 130′. The mass of the material in the conduit 130, 130′ is directly proportional to the density of the material. Therefore, the density of this material may be proportional to the square of a period at which the conduit 130, 130′ containing the material oscillates multiplied by the spring constant of the conduit 130, 130′. Hence, by determining the period at which the conduit 130, 130′ oscillates and by appropriately scaling the result, an accurate measure of the density of the material contained by the conduit 130, 130′ can be obtained. The meter electronics 20 can determine the period or resonance frequency using the sensor signals 165 and/or the drive signal 185. The conduits 130, 130′ may oscillate with more than one vibration mode.

Accordingly, a measured fluid parameter value, such as a measured flow rate, may be obtained. However, the measured fluid parameter value may have errors due to various issues. One of these issues may be related to a pressure in the conduit 130, 130′. The pressure in the conduit 130, 130′ may cause a shift in the structural properties, such as stiffness of the conduit. This change in stiffness can be compensated for by measuring a pipeline pressure and determining a pressure compensation of a measured fluid parameter value. However, under certain conditions, only using the measured pipeline pressure will include a pressure related error due to a pressure drop in the conduits 130, 130′. The following discusses in more detail a pressure compensation of a fluid flow parameter.

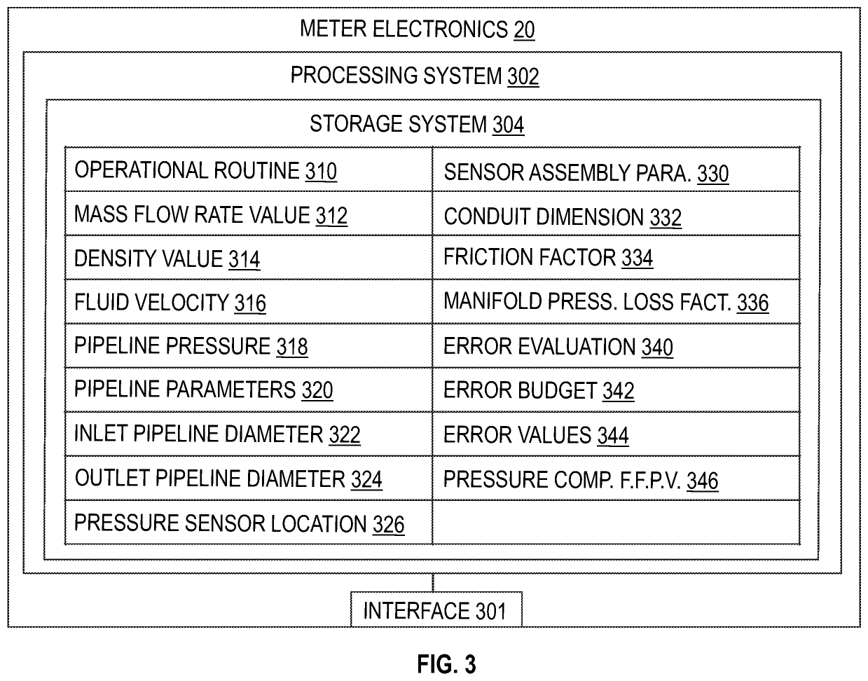

FIG. 3 shows a meter electronics 20 for pressure compensation of a fluid flow parameter value. As shown in FIG. 3, the meter electronics 20 includes an interface 301 and a processing system 302. The meter electronics 20 receives a vibrational response from a sensor assembly, such as the sensor assembly 10, for example. The meter electronics 20 processes the vibrational response in order to obtain flow properties of the flow material flowing through the sensor assembly 10. The meter electronics 20 may also perform checks, verifications, calibration routines, or the like, to ensure the fluid flow parameters of the flow material are accurately measured.

The interface 301 may receive the sensor signals 165 from one of the pick-off sensors 170l, 170r shown in FIGS. 2 and 3. The interface 301 can perform any necessary or desired signal conditioning, such as any manner of formatting, amplification, buffering, etc. Alternatively, some or all of the signal conditioning can be performed in the processing system 302. In addition, the interface 301 can enable communications between the meter electronics 20 and external devices. The interface 301 can be capable of any manner of electronic, optical, or wireless communication. The interface 301 can provide information based on the vibrational response. The interface 301 may be coupled with a digitizer, such as the CODEC 222 shown in FIG. 2, wherein the sensor signal comprises an analog sensor signal. The digitizer samples and digitizes an analog sensor signal and produces a digitized sensor signal.

The processing system 302 conducts operations of the meter electronics 20 and processes flow measurements from the sensor assembly 10. The processing system 302 executes one or more processing routines and thereby processes the flow measurements in order to produce one or more flow properties. The processing system 302 is communicatively coupled to the interface 301 and is configured to receive the information from the interface 301.

The processing system 302 can comprise a general-purpose computer, a micro-processing system, a logic circuit, or some other general purpose or customized processing device. Additionally, or alternatively, the processing system 302 can be distributed among multiple processing devices. The processing system 302 can also include any manner of integral or independent electronic storage medium, such as the storage system 304.

The storage system 304 can store vibratory meter parameters and data, software routines, constant values, and variable values. In one embodiment, the storage system 304 includes routines that are executed by the processing system 302, such as an operational routine 310 of the vibratory meter 5. The storage system can also store statistical values, such as a mean, standard deviation, confidence interval, etc., or the like.

The operational routine 310 may determine a mass flow rate value 312, a density value 314, and a fluid velocity 316 based on the sensor signals received by the interface 301. The mass flow rate value 312 may be determined from the sensor signals, such as a time delay between a left pickoff sensor signal and a right pickoff sensor signal. The density value 314 may also be determined from the sensor signals by, for example, determining a frequency from one or both of the left and right pickoff sensor signals. Also shown in FIG. 3, is a pipeline pressure 318. The pipeline pressure 318 may be a measured fluid pressure of a process fluid in a pipeline that is mechanically coupled to the flanges 103, 103′. The measured fluid pressure may be obtained by a pressure sensor mechanically coupled to the pipeline.

As shown in FIG. 3, the storage system 304 may also include pipeline parameters 320. The pipeline parameters 320 may be any parameter related to a pipeline that is mechanically coupled to the flanges 103, 103′ of the vibratory meter 5. As shown in FIG. 3, the pipeline parameters 320 include an inlet pipeline diameter 322, an outlet pipeline diameter 324, and a pressure sensor location 326. Additionally, or alternatively, other pipeline parameters may be employed. For example, alternative cross-sectional dimensions may be employed, such as, for example, radius or widths, may be employed where pipelines may not have a circular cross section. In another example, internal surface characteristics may be employed, such as surface roughness, curvatures, or the like may also be stored, depending on the desired level of accuracy.

The inlet pipeline diameter 322 and the outlet pipeline diameter 324 may have the same value. Accordingly, an alternative storage system may only store a pipeline diameter. The inlet pipeline diameter 322 and the outlet pipeline diameter 324 may be manually input by a user, provided by a computer over, for example, the port 26, etc. The pressure sensor location 326 may be, for example, a toggled value that indicates whether the pressure sensor is located upstream or downstream. Alternatively, the pressure sensor location 326 may be both upstream and downstream. Additional sensor location related parameters may be employed, such as, for example, a distance from the pressure sensors to the flanges 103, 103′.

Also shown in FIG. 3 are sensor assembly parameters 330. As shown in FIG. 3, the sensor assembly parameters 330 include a conduit dimension 332, a friction factor 334, and a manifold pressure loss factor 336. The conduit dimensions 332 may include a diameter and a length of a conduit, such as the conduits 130, 130′ described above. With more particularity, the conduits 130, 130′ may have circular cross-sections with an internal diameter that is stored as a value in the conduit dimensions 332. Similarly, the length of the conduits 130, 130′ may be an axial length of the conduits 130, 130′ extending from, for example, between the surfaces 121, 121′ of the mounting blocks 120, 120′. The friction factor 334 may be a measure of resistance to fluid flow that is related to an internal diameter of the conduits 130, 130′, but not a surface roughness of an internal or wetted surface of the conduits 130, 130′. The manifold pressure loss factor 336 may quantify a pressure loss caused by the manifolds 150, 150′ described in the foregoing. The manifold pressure loss factor 336 may be predetermined based on dimensions and other parameters of the manifolds 150, 150′. Additionally, or alternatively, other sensor assembly parameters may be employed.

The storage system 304 may also include error evaluation 340. The error evaluation 340 may determine, for example, whether an error may be present in a fluid flow parameter value. The error evaluation 340 can also determine an error due to pressure loss in the vibratory meter 5 and any evaluations that can be made using the error. As shown in FIG. 3, the error evaluation 340 includes an error budget 342, error values 344, and a pressure compensation fluid flow parameter value 346. The error budget 342 may be used to determine, for example, if any pressure compensation of a fluid flow parameter may be needed. For example, under some conditions, the pressure loss may not result in a significant error in a fluid flow parameter value. The error values 344 may be error values that result from pressure loss as well as any other causes, such as temperature drift, zero drift, etc. Accordingly, contributions of all of the errors to a total error of a fluid flow parameter value may be used to determine if the error due to pressure loss, or pressure loss error, is significant. The pressure compensated fluid flow parameter value 346 may be, for example, a pressure compensated density value, a pressure compensated mass flow rate value, etc.

As described in more detail in the following, a measured pressure, such as the pipeline pressure 318 described above, can be used to calculate a pressure that is used for pressure compensation of a fluid flow parameter value, such as the fluid flow parameters discussed above. For example, the fluid flow parameter may be a mass flow rate, a density, or any other suitable fluid flow parameter that is affected by a pressure of the fluid in a conduit, such as the conduits 130, 130′ discussed in the foregoing. A calculated pressure may depend on various dimensional parameters of the pipeline, inlet and outlet manifolds, conduit(s) of the vibratory meter as well as properties of the fluid flow, and/or the like.

As can be appreciated, these effects may or may not have a significant contribution to an error of the fluid flow parameter. For example, a relatively less dense fluid with a low fluid flow velocity measured in a conduit connected with manifolds having a near unitary diameter change ratio will not have a conduit pressure that differs significantly from the measured pressure of the inlet pipeline. As a result, using the measured pressure of the inlet pipeline for pressure compensation of a fluid flow parameter may not significantly contribute to an error of the fluid flow parameter. For example, a mass flow rate value pressure compensated with the measured pressure of the inlet pipeline may have an error contribution of less than 1 percent of a total error of the mass flow rate value.

However, using the measured pressure of the inlet pipeline for the pressure compensation of the fluid flow parameter may, in some cases, significantly contribute to an error of a pressure compensated fluid flow parameter value. Accordingly, using a calculated pressure of the fluid flow in a conduit, rather than a measured pressure of a pipeline, may help reduce an error of the pressure compensated fluid flow parameter. However, this reduction in error of the pressure compensated fluid flow parameter may be realized by using limited computing resources. Accordingly, suitable assumptions regarding the dimensions of the pipeline, inlet and/or outlet manifolds, and/or the conduit(s) of the vibratory meter may help optimize a tradeoff between a computing resource requirement and a contribution to an error of a pressure compensated fluid flow parameter value.

The following discussion illustrates determining when using a calculated pressure, such as a calculated conduit pressure, may help reduce an error of a pressure compensated fluid flow parameter value. The following discussion also explains how assumptions may be made to achieve a desired error of the pressure compensated fluid flow parameter value while optimally reducing the computing resources needed to achieve the desired error of the pressure compensated fluid flow parameter. The determination of when the calculated pressure and/or assumptions may be made can be performed online by detecting a condition or conditions and selecting an equation, or no equation, based on the detected condition for determining the calculated pressure used for pressure compensation of a fluid flow parameter.

### Bernoulli Equation for a Simplified Model of a Vibratory Meter

As an initial introduction, we begin with Bernoulli's energy equation, which can be expressed in “head” form without elevation changes as below equation [2],

$$\frac{{P}_{1}}{γ} + \frac{{V}_{1}^{2}}{2 g} = \frac{{P}_{2}}{γ} + \frac{{V}_{2}^{2}}{2 g} + \frac{Pressure Loss}{γ} ; \qquad [ 2 ]$$

where:
P₁ is a pressure in a pipeline coupled to a conduit, where, as used herein, the number “1” refers to the inlet pipeline;
V₁ is a velocity of a fluid in the pipeline and may be referred to as a pipeline fluid velocity;
P₂ is a conduit pressure of a vibratory meter that is in-line with the pipeline and may be referred to as a conduit fluid pressure;
V₂ is a velocity of the fluid in the conduit and may be referred to as a conduit fluid velocity;
γ is a density weight of the fluid, which may be expressed as γ=ρg, where ρ is a density of the fluid;
g is a gravitational constant; and
Pressure Loss is a value representing a decrease in pressure due to non-recoverable losses, such as friction (e.g., parasitic), turbulence, etc.
   The Pressure Loss term for frictional or parasitic losses over a length of the conduit may be expressed as:

$$Pressure loss = \frac{fL}{d} \frac{{V}_{C}^{2}}{2} ρ \qquad [ 3 ]$$

where:
f is a friction factor;
L is the length of the conduit of the vibratory meter containing the fluid; and
d is a diameter of the conduit of the vibratory meter.
   Accordingly, by substituting equation [3] for the Pressure Loss term in equation [2] and rearranging the resulting terms, equation [2] can be rewritten as:

$${P}_{C} = {P}_{1} + \frac{{V}_{1}^{2} ρ}{2} - \frac{{V}_{2}^{2} ρ}{2} ( 1 + \frac{fL}{d} ) ; \qquad [ 4 ]$$

where the terms have the same definitions as above except for the calculated pressure P_{C}, which has a subscript “C” to indicate that the calculated pressure value is used for determining a pressure compensated fluid flow parameter value. The pipeline fluid velocity V₁ may be significantly less than a conduit fluid velocity V₂. That is, a square of a pipeline fluid velocity V₁ value may be sufficiently smaller than a square of a conduit fluid velocity V₂ such that the

$$\frac{ρ {V}_{1}^{2}}{2}$$

term may be assumed to be zero. This assumption may be correct for pipelines having diameters that are 3 inches or larger, although the assumption may also be valid for smaller pipeline diameters. Accordingly, equation [4] above can be simplified to:

$${P}_{C} = {P}_{1} + 0 - \frac{{V}_{2}^{2} ρ}{2} ( 1 + \frac{fL}{d} ) ; where : \qquad [ 5 ]$$

$$\frac{{V}_{2}^{2} ρ}{2} ( 1 + \frac{{f}^{L}}{d} ) \qquad [ 6 ]$$

is a pressure loss term, as is expressed in the following equation [7]:

$$Pressure loss = - \frac{{V}_{2}^{2} ρ}{2} ( 1 + \frac{fL}{d} ) . \qquad [ 7 ]$$

Note that if the inlet pipeline fluid velocity V₁ is not assumed to be significantly smaller than the conduit fluid velocity V₂, the diameter of the inlet pipeline may be obtained and used in a calculation. Additionally, equation [2] may be rewritten to include a pressure loss term for the pipeline.

The conduit fluid velocity V₂ may be determined by a meter electronics based on a mass flow rate, a calculated viscosity of the fluid, and one or more dimensions of a conduit, such as the conduits 130, 130′. The meter electronics may be the meter electronics 20 discussed above, although any suitable meter electronics may be employed. The meter electronics may also be configured to determine a density p of the fluid. The meter electronics may also store and include geometric parameters of a sensor assembly, such as the sensor assembly 10 discussed above. The geometric parameters may include a length L and diameter d of the conduit(s). A friction factor f may also be stored in the meter electronics. Accordingly, the meter electronics may be configured to use the conduit fluid velocity V₂ and the density ρ of the fluid, as well as fluid related parameters of the sensor assembly that establishes the sensor characteristic fL/d. The meter electronics may therefore be configured to calculate a pressure, such as a pressure conduit, value for a given sensor assembly at various operating conditions.

For instance, a particular flow meter may have an fL/d value of approximately 1, although this value may not be constant versus Reynolds number (Re). As a result, the 1+fL/d of the above equation [7] may be approximated as “2”. As can be appreciated, above equation [7] only depends on density and conduit fluid velocity V₂. Accordingly, the only time a calculated pressure may significantly reduce an error of a pressure compensated fluid flow parameter value is when the conduit fluid velocity V₂ is relatively high. Under such conditions, the value of fL/d may be getting close to an asymptotic value of 1 so this may be a reasonable approximation.

Accordingly, a fluid flow parameter may be compensated by using the measured pressure value of the fluid in a pipeline at a predetermined location. A pressure compensated mass flow rate value may be obtained using, for example, a mass flow rate pressure effect value and a pressure loss value, although any suitable means of using the calculated conduit pressure can be employed. Although the foregoing discusses mass flow rate, the fluid flow parameter may be mass flow rate, density, viscosity, or any other suitable fluid flow parameter. In addition, any suitable means of using a calculated pressure P_{C} for determining a pressure compensated fluid flow parameter may be employed.

For example, a pressure compensated fluid flow parameter may be determined from a pressure effect term and a pressure drop term. The pressure drop term may be comprised of a dynamic or recoverable pressure drop and/or a permanent or non-recoverable pressure loss. Considering only the pressure loss term, the fluid flow pressure compensation may be determined from a fluid flow parameter pressure effect term (e.g., a fluid flow parameter change relative to a pressure change) and a fluid flow pressure loss term (e.g., frictional loss, shock loss, etc.).

Accordingly, where a pressure compensated mass flow rate value is desired, the following equation [8] may be employed:

Mass flow pressure compensation=Mass flow pressure effect*pressure loss. [8]

The pressure loss term may be included in an equation that results in a calculated pressure P_{C} that is used for determining a pressure compensated mass flow rate, such as those described herein. Accordingly, a compensated mass flow rate may be determined using a mass flow rate pressure compensation equation, such as the following equation [9]:

$${\dot{m}}_{Pcomp} = {\dot{m}}_{measured} ( 1 + {K}_{p m} * {P}_{C} ) ; \qquad [ 9 ]$$

where:
\dot{m}_{Pcomp} is a pressure compensated mass flow rate;
Kₚₘ is the mass flow rate pressure effect;
\dot{m}_{measured} is a mass flow rate measurement value that has not been compensated for pressure loss; and
P_{C} is a calculated pressure determined using, for example, the above equation [5], although any calculation may be employed. The calculated pressure P_{C} is used for pressure compensation of a fluid flow parameter and may be a conduit pressure P₂.

A similar method may be employed to determine a pressure compensated density value. For example, the density pressure compensation can be generally expressed as being dependent on a density pressure effect term and a pressure loss term, such as equation [10]:

Density pressure compensation=Density pressure effect*pressure loss, [10]

where:
Density pressure effect is a value that compensates for a pressure effect on a stiffness of the conduit; and
pressure loss is a pressure loss value associated with, for example, a conduit and can be determined using, for example, above equation [5].
   The pressure compensated density value of the fluid may be obtained by using a pressure compensated density equation, such as below equation [11]:

$$Pressure compensated density = ( Density measured ) + ( 1 + Kpd * {P}_{C} ) ; \qquad [ 11 ]$$

where:
Density measured is a measured density value of the fluid;
Kpd is the mass flow pressure effect; and
P_{C} is a calculated pressure of the fluid.
   The calculated pressure P_{C} used for determining a pressure compensated fluid flow parameter may be a conduit pressure P₂ value discussed above.

As can be appreciated, various parameters can be used to determine if a measured pipeline pressure or a calculated pressure P_{C}, such as a conduit pressure P₂, is used in pressure compensated fluid flow parameter equations. In addition, if it is determined that a calculated pressure P_{C} is to be used, then various assumptions can be made to minimize the computational resources required to achieve a desired error contribution of using the calculated pressure P_{C} to a fluid flow parameter value, as the following discussion illustrates.

### Pressure Losses in Vibratory Meters

Determining whether an assumption regarding pressure loss can be made may begin by understanding where pressure losses occur in a vibratory meter. A pressure loss, which may alternatively be referred to as non-recoverable or permanent pressure drop, can occur due to frictional losses between a fluid flow and a conduit containing the fluid flow, turbulence induced by surface features in the conduit, vibrations induced by fluid flow direction changes, etc.

In a vibratory meter, such as a Coriolis meter, there may be four main contributors to pressure loss: an inlet manifold, a length of the conduit, bends in the conduit, and the outlet manifold. The inlet and outlet manifold contribute to the pressure loss due to shock loss. A shock loss is a pressure loss induced by a non-smooth and/or significant change in the diameter of the manifold. The length of the conduit contributes to pressure loss via parasitic loss. The bends in the conduits can contribute to the pressure loss due to fluid pressure gradients between an outer and inner bend portion of the fluid flow. This pressure gradient can induce non-laminar flow, such as spiral flows, eddies, or the like, that causes a pressure loss additional to a frictional loss associated with a length of the bend in the conduit.

In the context of a dual conduit vibratory meter with an approximately 90° bend in the tubing, an inlet manifold of the dual conduit vibratory meter may split the fluid flow into two conduits and may reduce a cross sectional area of the fluid flow. An outlet manifold combines the two fluid flows into a single flow and may increase a cross sectional area of the fluid flow. In some dual conduit vibratory meters, the inlet and outlet manifold may also bend the fluid flow 90 degrees. These disruptions to the fluid flow can cause the fluid pressure to drop, some of which may be due to pressure losses, such as the pressure losses discussed above. For similar reasons, tube bends cause pressure loss that is a function of the bend radius.

A tube length of the conduit in the dual conduit vibratory meter may be referred to as a straight length of the conduit, even though the conduit may include a 90-degree bend. The straight length of the conduit is correlated with a frictional or parasitic pressure loss. The frictional or parasitic pressure loss induces a pressure drop that has a linear relationship with a length of the conduit. It is important to note that the frictional or parasitic pressure loss should not be confused with a friction factor, which is related to a diameter of a conduit. As the conduit diameter decreases the friction factor may increase according to, for example, Haaland's equation. The following Equation [12] outlines these pressure loss contributors:

$$Δ P = \frac{ρ \cdot {V}^{2}}{2} [ f \cdot \frac{L}{{D}_{H}} + ( {n}_{bends} ) ( \frac{bendangle}{90.0} ) \cdot {K}_{B} + {K}_{M} ] ; \qquad [ 12 ]$$

where:
ΔP is a pressure drop across the Coriolis meter example discussed above;
ρ is a density of the fluid flow;
V is a velocity of the fluid flow;

$$f \cdot \frac{L}{{D}_{H}}$$

is a parasitic loss term, in which:
f is the friction factor of the conduits;
L is a length of the conduit from the inlet manifold to the outlet manifold;
D_{H} is a hydraulic diameter of the conduits;

$$( {n}_{bends} ) ( \frac{bendangle}{90.0} ) \cdot {K}_{B}$$

is a bend loss term, in which:
n_{bends} is the number of bends in the conduit;
bendangle is the bend angle;
K_{B} is a loss coefficient of the bends of the conduits; and
K_{M} is manifold loss term expressed as a loss coefficient of the inlet and outlet manifold as well as any additional components that may be coupled to the inlet and outlet manifold, such as flanges, or the like.
   As can be appreciated, because the inlet and outlet manifolds are lumped together in a single term, there are three pressure loss terms even though there are four sources of the pressure loss.

### Determining a Calculated Pressure Value for Pressure Compensation

The above discussed pressure drop in many vibratory meters may not significantly affect fluid flow parameter values. Accordingly, an estimate of the conduit pressure may simply be a measured pressure of a fluid flow in an inlet and/or outlet pipeline connected to the vibratory meter. That is, if a dynamic pressure drop and permanent pressure loss does not significantly contribute to an error of a pressure compensated fluid flow parameter value, then a measured pipeline pressure may be employed. Employing the measured pipeline pressure may include numerical offsets that are approximations of a pressure drop in a sensor assembly, without estimating a conduit pressure by calculating a pressure in the conduit.

However, in some vibratory meters, the pressure drop in the sensor assembly may significantly affect the fluid flow parameter value. For example, the pressure drop may be significant in sensor assemblies with conduits having cross sectional areas that are significantly less than a pipeline connected to the sensor assembly. Additionally, or alternatively, the velocity of the fluid flow may be relatively high under certain circumstances. That is, for the same sensor assembly, a velocity of the fluid may determine whether or not a pressure loss significantly contributes to a measurement error of a fluid flow parameter value. These and other issues are discussed in the following when calculating a pressure for pressure compensation of a fluid flow parameter.

When the inlet pipeline pressure P₁ is measured, a calculated pressure P_{C} used for determining a pressure compensated fluid flow parameter may be proportional to a pressure drop that depends on both a dynamic or recoverable pressure drop and a pressure loss or non-recoverable pressure drop. The calculated pressure P_{C} used for determining a pressure compensated fluid flow parameter may also be based on an assumed chosen location in the vibratory meter. For example, the calculated pressure may be chosen to be at approximately half the length of the conduit. Accordingly, a pressure drop may only include pressure drops that result in a conduit pressure P₂ value with suitable assumptions that result in a meaningful estimate of a pressure midpoint of the conduit.

Additionally, the calculated pressure P_{C} may be based on either a measured inlet pipeline pressure P₁ measurement or an outlet pipeline pressure P₃ measurement. Assuming that the calculated pressure is a pressure at midpoint of the conduit, the following equations [13] and [14] may be employed, depending on where the pipeline pressure is measured:

$${P}_{c} = ( {P}_{1} + ρ \frac{{V}_{1}^{2}}{2} ) - \frac{1}{2} ( permanent pressure loss ) - ( dynamic pressure drop ) ; \qquad [ 13 ]$$

$${P}_{c} = ( {P}_{3} + ρ \frac{{V}_{3}^{2}}{2} ) + \frac{1}{2} ( permanent pressure loss ) - ( dynamic pressure drop ) ; \qquad [ 14 ]$$

where the terms are as described above.

When applying above equations [13] and [14] to geometries of a vibratory meter, a calculated pressure P_{C} used for pressure compensation of a fluid flow parameter estimating a pressure at approximately half the length of a conduit in a sensor assembly can be expressed in the following equation [15]:

$${P}_{C} = {P}_{1} - ( inlet manifold + \frac{1}{2} conduit length + 1 bend ) - ( dynamic pressure drop ) ; \qquad [ 15 ]$$

where:
P₁ is a measured pressure of an inlet pipeline;
inlet manifold is a pressure loss of an inlet manifold of the vibratory meter;
½ conduit length is pressure loss associated with half a length of a conduit in the vibratory meter; and
1 bend is a pressure loss associated with a single bend in the conduit. Expressing above equation [15] using the terms of above equation can result in the following equation [16]:

$${P}_{C} = {P}_{1} - \frac{ρ {V}_{2}^{2}}{2} ( {K}_{m inlet} + \frac{1}{2} \frac{fL}{d} + {K}_{b} ) - \frac{ρ {V}_{2}^{2}}{2} ; \qquad [ 16 ]$$

where:
P₁ is a measured pressure of an inlet pipeline;

$$\frac{ρ {V}_{2}^{2}}{2} ( {K}_{m inlet} + \frac{1}{2} \frac{fL}{d} + {K}_{b} )$$

is a permanent pressure loss term; and

$$\frac{ρ {V}_{2}^{2}}{2}$$

is a dynamic pressure loss term;
ρ is a density of the fluid;
V₂ is a velocity of the fluid in the conduit;
Kₘ is a manifold pressure loss factor of the inlet manifold;
f is a friction factor of the conduit;
L is an overall length of the conduit;
d is a diameter of the conduit; and
K_{b} is a bend pressure loss factor.
   As expressed in equation [16] a permanent pressure loss included in the calculated pressure P_{C} used for pressure compensation is approximately ½ of the total permanent pressure loss in a vibratory meter. However, this approximation may not be entirely complete because the pressure loss of the outlet manifold (where the flow area increases) is higher than the inlet manifold. In addition, as will be demonstrated after discussing calculating a pressure from a measured outlet pipeline pressure, the total permanent pressure loss may, in many cases, be small enough that the above estimation of the calculated pressure may not significantly contribute to an error of a fluid flow parameter value.

If the pressure measurement is downstream from the conduit, such as in an outlet pipeline, a pressure loss term is added to a dynamic pressure drop term. To calculate a pressure at the mid-point of a conduit, the following equation [17] where pressure losses associated with ½ of a length of the conduit of a sensor assembly, one bend, and an outlet manifold are included.

$${P}_{C} = {P}_{1} - ( outlet manifold + \frac{1}{2} conduit length + 1 bend ) - ( dynamic pressure drop ) \qquad [ 17 ]$$

Using the terms of above equation [14], equation [17] may be rewritten as the following equation [18]:

$${P}_{C} = {P}_{3} + \frac{ρ {V}_{2}^{2}}{2} ( {K}_{m inlet} + \frac{1}{2} \frac{fL}{d} + {K}_{b} ) - \frac{ρ {V}_{2}^{2}}{2} ; \qquad [ 18 ]$$

where the terms are defined above. Above equation [18] may be used for a measured outlet pipeline pressure P₃, where the manifold pressure loss factor Kₘ includes only a pressure loss of the outlet manifold.

As can be appreciated, the above equations may be employed to determine a contribution of a calculated pressure to an error of a fluid flow parameter. Determining the contribution of the calculated pressure to the error may be useful in determining if additional computing resources should be used to calculate the conduit pressure for particular conditions. For example, for relatively low flow rates, the calculated conduit pressure may not contribute significantly to the error of the fluid flow parameter. That is, the measured inlet and/or outlet pipeline pressure may be used to determine a pressure compensated fluid flow parameter because using the calculated or estimate conduit pressure may not result in significantly lower error.

For example, consider where a process fluid comprises a hydrocracked base oil HC-4 flowing through a dual tube Coriolis flow meter, such as the dual tube Coriolis flow meter discussed above. Process parameters of the process fluid may be 10,000 bbl/hour, density of 850 kg/m3, and a viscosity of 5 centipose (cP) in the dual tube Coriolis flow meter having a known friction factor and cross section fluid flow area. Using the above discussed assumptions related to equation [12], an exemplary result may be a total permanent pressure loss 9 pounds-per-square inch (psi) and a fluid velocity of 14 meters-per-second (m/s), although any suitable assumptions, friction factor, and cross section fluid flow area may be employed. Under such circumstances, the dynamic pressure loss may be calculated as follows:

$$Dynamic pressure loss = \frac{ρ {V}^{2}}{2} = \frac{( 850 \frac{kg}{{m}^{3}} ) 1 {4}^{2}}{2} = 83300 Pa = 0.8 = 12 psi .$$

An approximation of the conduit pressure may be based on an assumption that the conduit pressure P_{C} is half of the permanent loss and all of the dynamic loss.

Accordingly, if the conduit pressure P_{C} is calculated from an inlet pipeline pressure, P₁ may be calculated as follows:

$${P}_{C} = {P}_{1} - \frac{9}{2} - 12 = {P}_{1} - 16.5 psi$$

If the outlet pipeline pressure P₃ is measured, the conduit pressure P_{C} may be calculated according to the following:

$${P}_{C} = {P}_{3} + \frac{9}{2} - 12 = {P}_{3} - 7.5 psi$$

An exemplary pressure effect for the hydrocracked base oil HC-4 may have a pressure effect of approximately −0.0014% per psi. For example, due to pressure effects, a mass flow rate measurement of hydrocracked base oil HC-4 may have an error of about −0.0014% per psi of pressure. Accordingly, a difference of 16.5 psi and 7.5 psi may have a contribution of the error due to pressure effects on a mass flow rate value of about 9*(−0.0014)=0.01%. This difference in error contribution is not typically perceptible to many processes. Accordingly, whether an inlet pipeline pressure P₁ or an outlet pipeline pressure P₃ is utilized may not significantly contribute to an error of a fluid flow parameter value.

### Pipeline Assumptions

An inlet pipeline and an outlet pipeline may have the same diameter. Accordingly, when an inlet pipeline pressure is measured and a calculated pressure determined from the measured inlet pipeline pressure is used for pressure compensation of a fluid flow parameter value, the above discussed examples can be restated as the following equation [19]:

$${P}_{c} = {P}_{1} + ρ \frac{{V}_{1}^{2}}{2} - ρ \frac{{V}_{2}^{2}}{2} - \frac{1}{2} ( permanent pressure loss ) . \qquad [ 19 ]$$

Where an outlet pipeline pressure is measured and a calculated pressure determined from the measured outlet pipeline pressure is used for pressure compensation of a fluid flow parameter value, the above discussed examples can be restated as the following equation [20]:

$${P}_{c} = {P}_{3} + ρ \frac{{V}_{3}^{2}}{2} - ρ \frac{{V}_{2}^{2}}{2} + \frac{1}{2} ( permanent pressure loss ) . \qquad [ 20 ]$$

As can be appreciated, the assumption that an inlet pipeline diameter is equal to an outlet pipeline diameter may be known and stored in a meter electronics, such as the meter electronics 20 discussed above. The assumption may be made due to flanges, such as the flanges 103, 103′ discussed above, being installed during manufacturing. Accordingly, equation may be employed. As can also be appreciated, the permanent pressure loss term may be simplified by making assumptions about what structure(s) (e.g., manifolds, conduit, flanges, etc.) and/or feature(s) (e.g., bends, friction coefficients, etc.) significantly contribute to an error of the fluid flow parameter.

### System for Pressure Compensation of a Fluid Flow Parameter

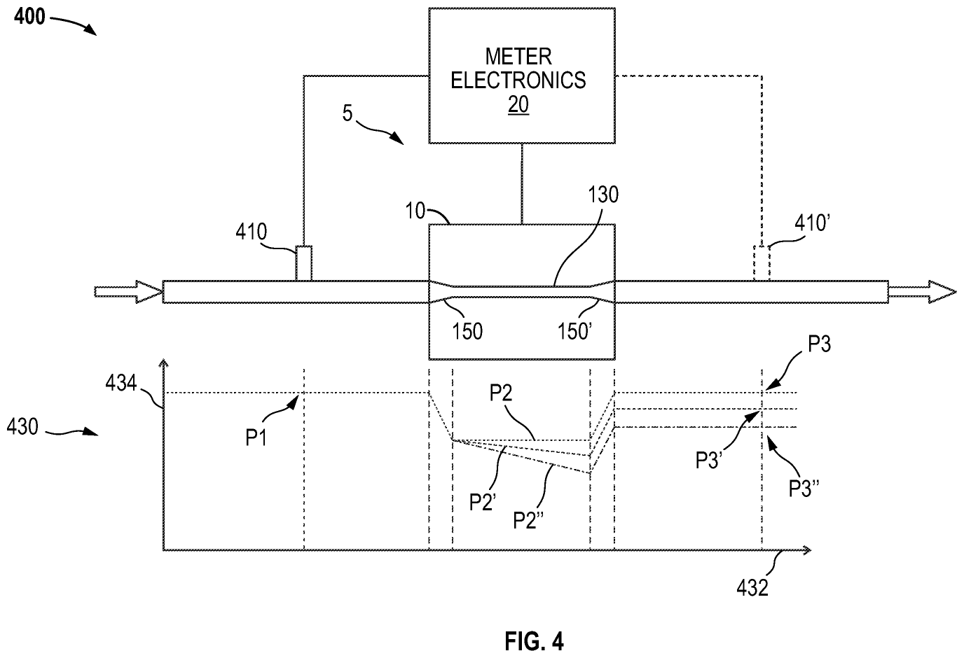

FIG. 4 shows a system 400 for pressure compensation of a flow meter parameter. As shown in FIG. 4, the system 400 includes an upstream pressure sensor 410 that is mechanically coupled to an upstream pipeline that receives and conveys a fluid indicated by an arrow. Also shown in dashed lines (the dashed lines indicating optional) is a downstream pressure sensor 410′ that is mechanically coupled to a downstream pipeline that conveys and provides the fluid indicated by an arrow. The vibratory meter 5 described in the foregoing is disposed in the pipelines. More specifically, the sensor assembly 10 is disposed between and mechanically coupled to the upstream pipeline and the downstream pipeline. The meter electronics 20 is also communicatively coupled to the sensor assembly 10. The sensor assembly 10 is shown as including a conduit 130 and manifolds 150, 150′, which may respectively be referred to as an inlet manifold and an outlet manifold. The manifolds 150, 150′ are mechanically coupled to the conduit 130 and the upstream pipeline and the downstream pipeline.

Also shown in FIG. 4 is a pressure graph 430 that shows a pressure of the fluid in the upstream and downstream pipelines and the sensor assembly 10. In particular, the pressure graph 430 includes location axis 432 and a pressure axis 434. The location axis 432 corresponds to locations in the upstream and downstream pipelines, the conduit 130, and the manifolds 150, 150′. The pressure of the fluid at the upstream pressure sensor 410 is indicated by an upstream pressure P1. The pressure of the fluid in the conduit is indicated by conduit pressures P2, P2′, P2″ comprising a first conduit pressure P2, a second conduit pressure P2′, and a third conduit pressure P2″. The conduit pressures P2, P2′, P2″ are illustrated by three lines indicating a pressure loss in the conduit 130 being different due to different parasitic loss terms. With more particularity, the first conduit pressure P2 has zero slope due to zero parasitic losses whereas the second and third conduit pressures P2′, P2″ have slopes due to parasitic losses.

Additionally, downstream pressures P3, P3′, P3″ are shown in FIG. 4. The downstream pressures P3, P3′, P3″ comprise a first downstream pressure P3, a second downstream pressure P3′, and a third downstream pressure P3″ at the downstream pressure sensor 410′. The downstream pressures P3, P3′, P3″ differ from each other due to parasitic losses in the conduit 130. The downstream pressures P3, P3′, P3″ do not differ from each other due to non-parasitic pressure changes in manifolds. The downstream pressures P3, P3′, P3″ are also not different due to any parasitic losses in the pipelines because the parasitic losses in the pipelines are at or substantially near zero.

As can be appreciated, there may be, in other systems, other parasitic losses in an alternative vibratory meter's sensor assembly, such as the sensor assembly's manifolds and/or pipelines. Accordingly, an alternative pressure graph may include, for example, pipeline pressure drops as well as non-recovered pressure changes in the manifolds.

The foregoing discussion illustrates how a method may determine a pressure for pressure compensation of a fluid flow parameter. The method may take into account various operational parameters, such as pipeline diameters, fluid velocity, conduit diameter, manifold factors, or the like to both calculate a pressure and to determine if the calculated pressure may be used for determining a pressure compensated fluid flow parameter. That is, determining a pressure for pressure compensation of a fluid flow parameter may include calculating the pressure and determining if the calculated pressure may be used for pressure compensation of the fluid flow parameter.

### Selecting a Pressure for Pressure Compensation

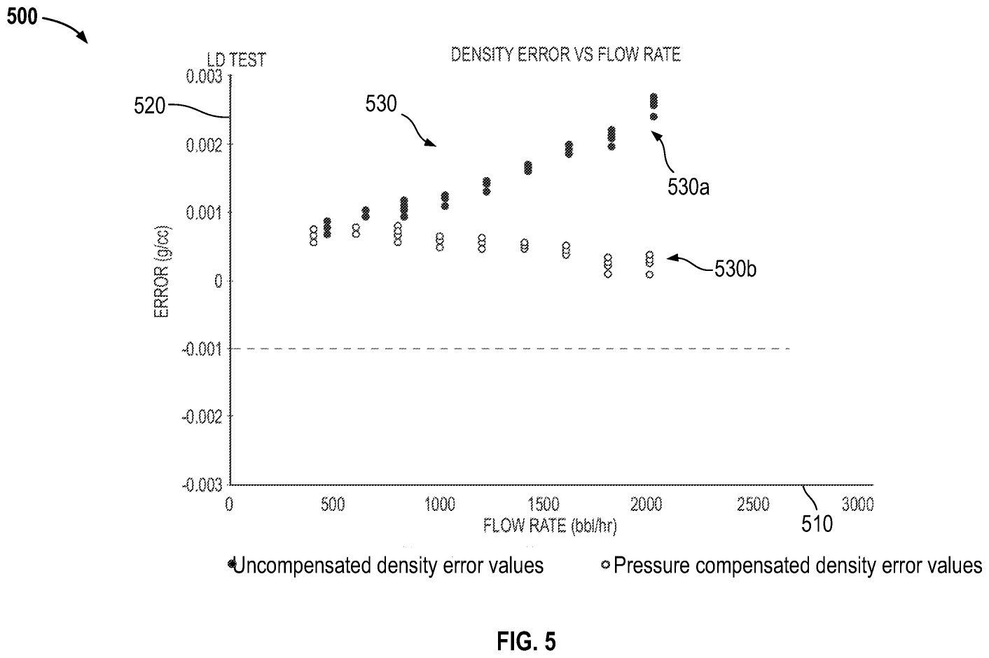

FIG. 5 shows a graph 500 illustrating a pressure compensation of a fluid flow parameter. As shown in FIG. 5, the graph 500 includes flow rate axis 510 in barrels-per-hour (bbl/hr) and a density error axis 520 in grams-per-cubic centimeter (g/cm). Also shown are density error plot 530. As can be seen, the density error plot 530 includes uncompensated density error plot 530a indicated by solid filled circles and pressure compensated density error plot 530b indicated by unfilled circles.

The uncompensated density error plot 530a and the pressure compensated density error plot 530b may be comprised of a difference between a measured density value and a reference density value. For example, the uncompensated density error plot 530a may be comprised of differences between uncompensated measured density values and a reference density value of the fluid. Similarly, the pressure compensated density error plot 530b may be comprised of pressure compensated measured density values and the reference density value.

The uncompensated density error plot 530a increases as the flow rate of a fluid flowing through a vibratory meter increases. The increase in the uncompensated density error plot 530a suggest that a pressure drop due to the increasing flow rate of the fluid flowing through the vibratory meter suggests that a pressure drop affects a vibratory frequency of the vibratory meter. More specifically, the greater the pressure drop through a length of a conduit in the vibratory meter, the greater the uncompensated density error plot 530a. Similar results may be obtained with other fluid parameters, such as a measured mass or volume flow rate. Accordingly, at relatively low flow rates, a fluid flow parameter error may be negligible whereas at higher pressure losses due to a higher flow rate of the fluid, the fluid flow parameter error may significantly contribute to an error budget of a measured value of a fluid flow parameter.

The above discusses various aspects of pressure compensation of a fluid flow parameter value including the vibratory meter 5 and the meter electronics 20 that may perform such compensation, an example of which is discussed in the following.

### Method for Pressure Compensation

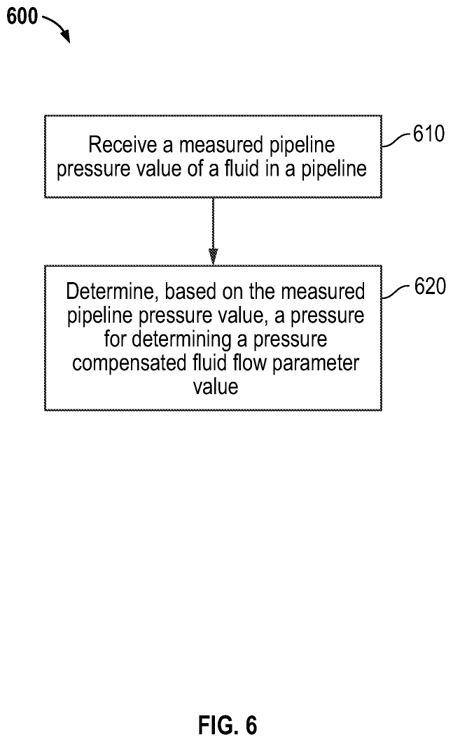

FIG. 6 shows a method 600 for pressure compensation of a fluid flow parameter. As shown in FIG. 6, the method 600 may receive a measured pipeline pressure value of a fluid in a pipeline in step 610. By way of illustration, the method 600 may be executed on the meter electronics 20 described above and therefore the method 600 executing on the meter electronics 20 may receive a measured pipeline pressure value from the downstream pressure sensor 410 and/or the downstream pressure sensor 410′. However, any suitable vibratory meter and meter electronics may be employed. In step 620, the method 600 may determine, based on the measured pipeline pressure value, a pressure for determining a pressure compensated fluid flow parameter value.

In step 620, the pressure for determining the pressure compensated fluid flow parameter value may be determined based on, for example, the foregoing equations [13] and [14], which relate a calculated pressure P_{C} of a fluid in a conduit, such as the conduits 130, 130′ discussed above, with a measured pressure, half of a permanent pressure loss, and dynamic pressure loss. The pressure for determining the pressure compensated fluid flow parameter value may be based on a pressure loss associated with components in a vibratory meter, such as the conduit 130, 130′ and the manifolds 150, 150′. The pressure loss associated with the conduit may be frictional pressure loss and/or a bend pressure loss of the conduit. For example, the pressure for determining the pressure compensated fluid flow parameter value may be determined using foregoing equations [16] and/or [18].

The method 600 may also determine if a calculated pressure or a measured pressure of the pipeline should be used to determine a pressure compensated fluid flow parameter value. For example, the method 600 may determine that using the measured pressure of the pipeline may not significantly contribute to an error budget of a measured value of the fluid flow parameter. The method 600 may make such a determination by, for example, comparing one or more fluid properties, such as a mass flow rate, fluid velocity, density, frequency, etc., to corresponding thresholds. For example, as discussed above with reference to FIG. 5, a measured value of density may not have a significant error at relatively low flow rates. Accordingly, the measured pressure of the pipeline may be used to determine the pressure compensated fluid flow parameter value if a measured value of an uncompensated mass flow rate is less than a pressure compensation mass flow rate threshold. Similar thresholds may be employed with fluid velocity, volume flow rates or the like.

Additionally, or alternatively, a comparison may be made between the calculated pressure value and the measured pressure value. For example, if a difference between the calculated pressure and the measured pressure is less than a pressure compensation pressure difference threshold, then the measured pipeline pressure value may be employed as the pressure for determining the pressure compensated fluid flow parameter. As can be appreciated, the above and additional comparisons may be employed alone or in combination. For example, the measured pipeline pressure may be used as the pressure for determining the pressure compensated fluid flow parameter value if both the measured mass flow rate and the pressure difference are below their respective thresholds.

Additionally, or alternatively, the method 600 may also determine an error of the pressure compensated fluid flow parameter. For example, the method 600 may, for fluids of a known density value but varying mass flow rates, determine an error of an uncompensated density value with a reference density value. By way of illustration, the density value may be known because a process being monitored by the vibratory meter 5 uses an unchanging fluid composition. Alternatively, a density meter may be communicatively coupled with the meter electronics 20 so as to provide a measured value of the density of the fluid that is independent of any pressure drops in the vibratory meter 5.

As can be appreciated, the determination whether to use a calculated pressure of the conduit or a measured pressure of the pipeline can be cascaded so as to reduce a computational load on the meter electronics 20. For example, an initial assessment may be made whether a process parameter has an error. By way of illustration, a measurement parameter, such as a resonant frequency of the conduit 130, 130′, may change even though the fluid flowing through the vibratory meter 5 may have a known and constant density. Additionally, the method 600 may also compare such a change to previously determined correlation between a change in frequency (e.g., a slope similar to the slope of the uncompensated density error plot 530a of FIG. 5) and a flow rate of the fluid. Accordingly, if the method 600 detects an unexpected change, or process parameter error, then the method 600 may proceed to determine a calculated pressure of the fluid in the conduit 130, 130′, an error of a fluid flow parameter value, and/or a pressure compensated fluid flow parameter value.

The vibratory meter 5, meter electronics 20, and method 600 described above provide pressure compensation of a fluid flow parameter. The pressure compensation may be of a fluid flow parameter that is measured by a vibratory meter, such as a Coriolis flow meter. The vibratory meter 5, meter electronics 20, and method 600 can determine whether the fluid flow parameter may have an error prior to performing any calculations thereby reducing a computational load on the meter electronics 20. Additionally, or alternatively, the vibratory meter 5, meter electronics 20, and method 600 can determine whether the error is a significant contributor to an error of a fluid flow parameter value. This may also help reduce the computational load on the meter electronics 20 by avoiding a real-time calculation of a pressure compensated fluid flow parameter, such as the pressure compensated mass flow rate or density discussed above. Additionally, or alternatively, the vibratory meter 5, meter electronics 20, and method 600 can also calculate a pressure compensated fluid flow parameter by using a calculated pressure of the fluid in the conduit to reduce the error of the fluid flow parameter value.

The vibratory meter 5, meter electronics 20, and method 600 may also make such determinations and calculations regardless of the location of one or more pressure sensors, such as the upstream and downstream pressure sensors 410, 410′ discussed above. More specifically, a user may only need to answer a query during installation of the vibratory meter 5 that the pressure sensor is upstream from the vibratory meter 5. Accordingly, the method 600 may use this input from the user to employ equations that use an upstream measured pressure, such as above equation [4]. Additionally, or alternatively, a downstream pressure sensor may be used. The meter electronics 20 can then inform the user that any pressure losses due to frictional losses is automatically compensated for in a fluid flow parameter value under all fluid flow conditions.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other vibratory meters, meter electronics, and methods for a pressure compensation of a fluid flow parameter, and not just to the embodiments described above and shown in the accompanying figures. Accordingly, the scope of the embodiments described above should be determined from the following claims.

We claim:

1. A method of pressure compensation of a fluid flow parameter, the method comprising:
receiving a measured pipeline pressure value of a fluid in a pipeline; and
determining, based on the measured pipeline pressure value, a pressure for determining a pressure compensated fluid flow parameter value.

2. The method of claim 1, wherein the measured pipeline pressure value comprises one of a measured inlet pipeline pressure value and a measured outlet pipeline pressure value.

3. The method of claim 2, wherein determining, based on the measured pipeline pressure value, the pressure for determining the pressure compensated fluid flow parameter value comprises determining a calculated pressure based on one of the following equations:
$${P}_{c} = ( {P}_{1} + ρ \frac{{V}_{1}^{2}}{2} ) - \frac{1}{2} ( permanent pressure loss ) - ( dynamic pressure drop ) ; and$$
$${P}_{c} = ( {P}_{3} + ρ \frac{{V}_{3}^{2}}{2} ) + \frac{1}{2} ( permanent pressure loss ) - ( dynamic pressure drop ) ;$$
where:
P₁ is the measured inlet pipeline pressure value;
V₁ is a velocity of the fluid in an inlet pipeline;
P₃ is the measured outlet pipeline pressure value;
V₃ is a velocity of the fluid in the outlet pipeline;
P_{c} is the calculated pressure;
ρ is a density of the fluid;
(permanent pressure loss) is a permanent pressure loss value of a vibratory meter connected to the pipeline; and
(dynamic pressure drop) is a dynamic pressure drop associated with a diameter difference between a conduit of the vibratory meter and a pipeline connected to the vibratory meter.

4. The method of claim 1, wherein the pressure for determining the pressure compensated fluid flow parameter value is based on a pressure loss associated with at least one of a conduit, an inlet manifold, and an outlet manifold.

5. The method of claim 4, wherein the pressure loss associated with the conduit comprises at least one of a friction pressure loss and a bend pressure loss of the conduit.

6. The method of claim 4, wherein the pressure for determining the pressure compensated fluid flow parameter value comprises one of the following equations:
$${P}_{C} = {P}_{1} - \frac{ρ {V}_{2}^{2}}{2} ( {K}_{m inlet} + \frac{1}{2} \frac{fL}{d} + {K}_{b} ) - \frac{ρ {V}_{2}^{2}}{2} ; and$$
$${P}_{C} = {P}_{3} + \frac{ρ {V}_{2}^{2}}{2} ( {K}_{m inlet} + \frac{1}{2} \frac{fL}{d} + {K}_{b} ) - \frac{ρ {V}_{2}^{2}}{2} ;$$
where:
P₁ is a measured pressure of an inlet pipeline;
$$\frac{ρ {V}_{2}^{2}}{2} ( {K}_{m inlet} + \frac{1}{2} \frac{fL}{d} + {K}_{b} )$$
is a permanent pressure loss term;
$$\frac{ρ {V}_{2}^{2}}{2}$$
is a dynamic pressure loss term;
ρ is a density of the fluid;
V₂ is a velocity of the fluid in the conduit;
K_{m inlet} is a manifold pressure loss factor;
f is a friction factor of the conduit;
L is an overall length of the conduit;
d is a diameter of the conduit; and
K_{b} is a bend pressure loss factor.

7. The method of claim 1, wherein determining, based on the measured pipeline pressure value, a pressure for determining a pressure compensated fluid flow parameter value comprises determining if the pressure for determining the pressure compensated fluid flow parameter value is one of a calculated pressure value and the measured pipeline pressure value.

8. The method of claim 1, wherein determining, based on the measured pipeline pressure value, the pressure for determining the pressure compensated fluid flow parameter value comprises determining an error of the pressure compensated fluid flow parameter value.

9. A meter electronics (20) configured for pressure compensation of a fluid flow parameter value, the meter electronics (20) comprising:
an interface (301) configured to communicatively couple to a pressure sensor configured to measure a pipeline pressure of a fluid in the pipeline; and
a processing system (302) communicatively coupled to the interface (301), the processing system (302) being configured to:
receive a measured pipeline pressure value of a fluid in a pipeline; and
determine, based on the measured pipeline pressure value, a pressure for determining a pressure compensated fluid flow parameter value.

10. A vibratory meter (5) configured to determine a pressure for pressure compensation of a fluid flow parameter value, the vibratory meter (5) comprising:
a sensor assembly (10) configured to provide sensor signals; and
a meter electronics (20) communicatively coupled to the sensor assembly (10), the meter electronics (20) being configured to:
receive the sensor signals;
receive a measured pipeline pressure value of a fluid in a pipeline; and determine, based on the measured pipeline pressure value, a pressure for determining a pressure compensated fluid flow parameter value.

11. A system (400) for determining a pressure for pressure compensation of a fluid flow parameter value, the system (400) comprising:
a pressure sensor (410) configured to measure pipeline pressure;
a vibratory meter (5) communicatively coupled to the pressure transducer, the vibratory meter (5) being configured to:
receive a measured pipeline pressure value of the fluid in a pipeline; and
determine, based on the measured pipeline pressure value, a pressure for determining a pressure compensated fluid flow parameter value.

12. The meter electronics (20) of claim 9, wherein the measured pipeline pressure value comprises one of a measured inlet pipeline pressure value and a measured outlet pipeline pressure value.

13. The meter electronics (20) of claim 12, wherein the processing system (302) being configured to determine, based on the measured pipeline pressure value, the pressure for determining the pressure compensated fluid flow parameter value comprises the processing system (302) being configured to determine a calculated pressure based on one of the following equations:
$${P}_{c} = ( {P}_{1} + ρ \frac{{V}_{1}^{2}}{2} ) - \frac{1}{2} ( permanent pressure loss ) - ( dynamic pressure drop ) ; and$$
$${P}_{c} = ( {P}_{3} + ρ \frac{{V}_{3}^{2}}{2} ) + \frac{1}{2} ( permanent pressure loss ) - ( dynamic pressure drop ) ;$$
where:
P₁ is the measured inlet pipeline pressure value;
V₁ is a velocity of the fluid in an inlet pipeline;
P₃ is the measured outlet pipeline pressure value;
V₃ is a velocity of the fluid in the outlet pipeline;
P_{c} is the calculated pressure;
ρ is a density of the fluid;
(permanent pressure loss) is a permanent pressure loss value of a vibratory meter connected to the pipeline; and
(dynamic pressure drop) is a dynamic pressure drop associated with a diameter difference between a conduit of the vibratory meter and a pipeline connected to the vibratory meter.

14. The meter electronics (20) of claim 9, wherein the pressure for determining the pressure compensated fluid flow parameter value is based on a pressure loss associated with at least one of a conduit, an inlet manifold, and an outlet manifold.

15. The meter electronics (20) of claim 14, wherein the pressure loss associated with the conduit comprises at least one of a friction pressure loss and a bend pressure loss of the conduit.

16. The meter electronics (20) of claim 14, wherein the pressure for determining the pressure compensated fluid flow parameter value comprises one of the following equations:
$${P}_{C} = {P}_{1} - \frac{ρ {V}_{2}^{2}}{2} ( {K}_{m inlet} + \frac{1}{2} \frac{fL}{d} + {K}_{b} ) - \frac{ρ {V}_{2}^{2}}{2} ; and$$
$${P}_{C} = {P}_{3} + \frac{ρ {V}_{2}^{2}}{2} ( {K}_{m inlet} + \frac{1}{2} \frac{fL}{d} + {K}_{b} ) - \frac{ρ {V}_{2}^{2}}{2} ;$$
where:
P₁ is a measured pressure of an inlet pipeline;
$$\frac{ρ {V}_{2}^{2}}{2} ( {K}_{m inlet} + \frac{1}{2} \frac{fL}{d} + {K}_{b} )$$
is a permanent pressure loss term;
$$\frac{ρ {V}_{2}^{2}}{2}$$
is a dynamic pressure loss term;
ρ is a density of the fluid;
V₂ is a velocity of the fluid in the conduit;
K_{m inlet} is a manifold pressure loss factor;
f is a friction factor of the conduit;
L is an overall length of the conduit;
d is a diameter of the conduit; and
K_{b} is a bend pressure loss factor.

17. The meter electronics (20) of claim 9, wherein the processing system (302) being configured to determine, based on the measured pipeline pressure value, a pressure for determining a pressure compensated fluid flow parameter value comprises the processing system (302) being configured to determine if the pressure for determining the pressure compensated fluid flow parameter value is one of a calculated pressure value and the measured pipeline pressure value.

18. The meter electronics (20) of claim 9, wherein the processing system (302) being configured to determine, based on the measured pipeline pressure value, the pressure for determining the pressure compensated fluid flow parameter value comprises the processing system (302) being configured to determine an error of the pressure compensated fluid flow parameter value.

19. The vibratory meter (5) of claim 10, wherein the measured pipeline pressure value comprises one of a measured inlet pipeline pressure value and a measured outlet pipeline pressure value.

20. The vibratory meter (5) of claim 19, wherein the meter electronics (20) being configured to determine, based on the measured pipeline pressure value, the pressure for determining the pressure compensated fluid flow parameter value comprises the meter electronics (20) being configured to determine a calculated pressure based on one of the following equations:
$${P}_{c} = ( {P}_{1} + ρ \frac{{V}_{1}^{2}}{2} ) - \frac{1}{2} ( permanent pressure loss ) - ( dynamic pressure drop ) ; and$$
$${P}_{c} = ( {P}_{3} + ρ \frac{{V}_{3}^{2}}{2} ) + \frac{1}{2} ( permanent pressure loss ) - ( dynamic pressure drop ) ;$$
where:
P₁ is the measured inlet pipeline pressure value;
V₁ is a velocity of the fluid in an inlet pipeline;
P₃ is the measured outlet pipeline pressure value;
V₃ is a velocity of the fluid in the outlet pipeline;
P_{c} is the calculated pressure;
ρ is a density of the fluid;
(permanent pressure loss) is a permanent pressure loss value of a vibratory meter connected to the pipeline; and
(dynamic pressure drop) is a dynamic pressure drop associated with a diameter difference between a conduit of the vibratory meter and a pipeline connected to the vibratory meter.

21. The vibratory meter (5) of claim 10, wherein the pressure for determining the pressure compensated fluid flow parameter value is based on a pressure loss associated with at least one of a conduit, an inlet manifold, and an outlet manifold.

22. The vibratory meter (5) of claim 21, wherein the pressure loss associated with the conduit comprises at least one of a friction pressure loss and a bend pressure loss of the conduit.

23. The vibratory meter (5) of claim 21 wherein the pressure for determining the pressure compensated fluid flow parameter value comprises one of the following equations:
$${P}_{C} = {P}_{1} - \frac{ρ {V}_{2}^{2}}{2} ( {K}_{m inlet} + \frac{1}{2} \frac{fL}{d} + {K}_{b} ) - \frac{ρ {V}_{2}^{2}}{2} ; and$$
$${P}_{C} = {P}_{3} + \frac{ρ {V}_{2}^{2}}{2} ( {K}_{m inlet} + \frac{1}{2} \frac{fL}{d} + {K}_{b} ) - \frac{ρ {V}_{2}^{2}}{2} ;$$
where:
P₁ is a measured pressure of an inlet pipeline;
$$\frac{ρ {V}_{2}^{2}}{2} ( {K}_{m inlet} + \frac{1}{2} \frac{fL}{d} + {K}_{b} )$$
is a permanent pressure loss term;
$$\frac{ρ {V}_{2}^{2}}{2}$$
is a dynamic pressure loss term;
ρ is a density of the fluid;
V₂ is a velocity of the fluid in the conduit;
K_{m inlet} is a manifold pressure loss factor;
f is a friction factor of the conduit;
L is an overall length of the conduit;
d is a diameter of the conduit; and
K_{b} is a bend pressure loss factor.

24. The vibratory meter (5) of claim 10, wherein the meter electronics (20) being configured to determine, based on the measured pipeline pressure value, a pressure for determining a pressure compensated fluid flow parameter value comprises the meter electronics (20) being configured to determine if the pressure for determining the pressure compensated fluid flow parameter value is one of a calculated pressure value and the measured pipeline pressure value.

25. The vibratory meter (5) of claim 10, wherein the meter electronics (20) being configured to determine, based on the measured pipeline pressure value, the pressure for determining the pressure compensated fluid flow parameter value comprises the meter electronics (20) being configured to determine an error of the pressure compensated fluid flow parameter value.

26. The system (400) of claim 11, wherein the measured pipeline pressure value comprises one of a measured inlet pipeline pressure value and a measured outlet pipeline pressure value.

27. The system (400) of claim 26, wherein the vibratory meter (5) being configured to determine, based on the measured pipeline pressure value, the pressure for determining the pressure compensated fluid flow parameter value comprises the vibratory meter (5) being configured to determine a calculated pressure based on one of the following equations:
$${P}_{c} = ( {P}_{1} + ρ \frac{{V}_{1}^{2}}{2} ) - \frac{1}{2} ( permanent pressure loss ) - ( dynamic pressure drop ) ; and$$
$${P}_{c} = ( {P}_{3} + ρ \frac{{V}_{3}^{2}}{2} ) + \frac{1}{2} ( permanent pressure loss ) - ( dynamic pressure drop ) ;$$
where:
P₁ is the measured inlet pipeline pressure value;
V₁ is a velocity of the fluid in an inlet pipeline;
P₃ is the measured outlet pipeline pressure value;
V₃ is a velocity of the fluid in the outlet pipeline;
P_{c} is the calculated pressure;
ρ is a density of the fluid;
(permanent pressure loss) is a permanent pressure loss value of a vibratory meter connected to the pipeline; and
(dynamic pressure drop) is a dynamic pressure drop associated with a diameter difference between a conduit of the vibratory meter and a pipeline connected to the vibratory meter.

28. The system (400) of claim 11, wherein the pressure for determining the pressure compensated fluid flow parameter value is based on a pressure loss associated with at least one of a conduit, an inlet manifold, and an outlet manifold.

29. The system (400) of claim 28, wherein the pressure loss associated with the conduit comprises at least one of a friction pressure loss and a bend pressure loss of the conduit.

30. The system (400) of claim 28, wherein the pressure for determining the pressure compensated fluid flow parameter value comprises one of the following equations:
$${P}_{C} = {P}_{1} - \frac{ρ {V}_{2}^{2}}{2} ( {K}_{m inlet} + \frac{1}{2} \frac{fL}{d} + {K}_{b} ) - \frac{ρ {V}_{2}^{2}}{2} ; and$$
$${P}_{C} = {P}_{3} + \frac{ρ {V}_{2}^{2}}{2} ( {K}_{m inlet} + \frac{1}{2} \frac{fL}{d} + {K}_{b} ) - \frac{ρ {V}_{2}^{2}}{2} ;$$
where:
P₁ is a measured pressure of an inlet pipeline;
$$\frac{ρ {V}_{2}^{2}}{2} ( {K}_{m inlet} + \frac{1}{2} \frac{fL}{d} + {K}_{b} )$$
is a permanent pressure loss term;
$$\frac{ρ {V}_{2}^{2}}{2}$$
is a dynamic pressure loss term;
ρ is a density of the fluid;
V₂ is a velocity of the fluid in the conduit;
K_{m inlet} is a manifold pressure loss factor;
f is a friction factor of the conduit;
L is an overall length of the conduit;
d is a diameter of the conduit; and
K_{b} is a bend pressure loss factor.

31. The system (400) of claim 11, wherein the vibratory meter (5) being configured to determine, based on the measured pipeline pressure value, a pressure for determining a pressure compensated fluid flow parameter value comprises the vibratory meter (5) being configured to determine if the pressure for determining the pressure compensated fluid flow parameter value is one of a calculated pressure value and the measured pipeline pressure value.

32. The system (400) of claim 11, wherein the vibratory meter (5) being configured to determine, based on the measured pipeline pressure value, the pressure for determining the pressure compensated fluid flow parameter value comprises the vibratory meter (5) being configured to determine an error of the pressure compensated fluid flow parameter value.
